(19) United States
(12) Patent Application Publication
(10) Pub. No.: US 2011/0292928 A1
(43) Pub. Date: Dec. 1, 2011

(54) METHOD, MODEM AND SERVER FOR BRIDGING TELEPHONE CALLS INTO INTERNET CALLS

(76) Inventors: Aihao Yin, Shanghai (CN); Xin Wang, Shanghai (CN)

(21) Appl. No.: 12/672,360

(22) PCT Filed: Aug. 7, 2008
(86) PCT No.: PCT/CN08/71917

§ 371 Date: Feb. 5, 2010

(30) Foreign Application Priority Data
Aug. 8, 2007 (CN) 200710140275.5

(51) Int. Cl. H04L 12/66

(52) U.S. Cl. 370/352

(57) ABSTRACT

The present invention relates to a method for bridging traffic in analogue channel into digital channel using Asymmetrical Digital Subscriber Line, said method comprises: step of PSTN network connecting, in which caller and callee ADSLs establish PSTN network connection using PSTN signaling in the analogue channel; step of discovering Internet call, in which the caller ADSL sends Internet call setup message to Internet call server, the caller ADSL and the callee ADSL make Internet call discovery procedure on the Internet and determine successful Internet call discovery; step of setting up Internet connection, in which the caller and callee ADSLs set up Internet connection in the digital channel by means of the successful Internet call discovery; step of bridging the PSTN network connection to the Internet, in which the caller and the callee ADSLs bridge the PSTN network connection to the Internet via the Internet connection which has been set up, and release the analogue channel. The invention further relates a modem and a Internet call server used in the method.

### CROSS REFERENCE TO RELATED APPLICATION

This application claims the benefit of CN application No. 200710140275.5, which is incorporated here by reference.

### TECHNICAL FIELD OF THE INVENTION

The present invention relates to a calling method of Public Switch Telephone Network (PSTN), in particular to a method for transferring PSTN calls into Internet using Asymmetrical Digital Subscriber Line (ADSL), an ADSL modem for transferring PSTN calls into Internet, and further an Internet call server for carrying out call discovery and connection between ADSLs.

### BACKGROUND OF THE INVENTION

Most of the traditional telecommunication service providers are moving their traffic from the traditional circuit switched PSTN network to the low cost IP network. To achieve this, the service providers need to deploy the VoIP gateways at the edge of their IP network to connect the Class 5 PSTN switches, as tandem or toll replacement.

Some new Internet service providers, such as Skype, prefer to use Internet as bear of IP voice. However, the calls are mostly made between PCs with Internet ID, e.g. Skype user ID, instead of phone users. The Skype users have to get registered to the Internet so that to be able to make or receive calls. To terminate a Skype call to PSTN, which was called SkypeOut, the VoIP gateways are also needed. However, the users can never make a call from an analogue phone to the Skype users, as shown in FIG. 2.

ADSL technology is a modem technology that uses existing twisted-pair telephone lines to transport high-bandwidth data, such as multimedia and video, to serve subscribers that have a phone equipped. The ADSL equipments deployed at both ends of the phone line permit the simultaneous transferring of digital Internet traffic and analogue phone traffic, at different frequencies on the same line, without affecting each other. This allows the users to remain connected to the Internet whilst making and receiving telephone calls and faxes. With an ADSL modem deployed at user's residence and the DSLAM deployed at the service provider's office, the telephone channel is split off from the digital modem by filters, thus guaranteeing uninterrupted basic telephone service, even if ADSL fails. In general, we will use terms “analogue channel” and “digital channel” to indicate the different channels beared by the twisted phone line. The analogue channel is a channel through public switched telephone network and the digital channel is a channel through Internet. See FIG. 3 for the architecture of ADSL, the dash-dot-dot lines represent the digital channels and the dot-and-dash lines represent the analogue channels.

More and more traditional telephone service providers are deploying their ADSL services. Since an ADSL subscriber can remain connected to the Internet continuously with high band width, and that the user can use traditional phone and Internet access simultaneously, the ADSL is superior than the earlier dial-up modem technologies. That also why it has been widely deployed for accessing the Internet.

And in the meanwhile, more and more Internet VoIP service providers are deploying their VoIP service over Internet. In general a Plain Old Telephone Service (POTS) phone user with ADSL service could connect its computer to Internet through the digital channel in the twisted-pair phone line, they could enjoy the Internet VoIP service via ADSL using a specific software (e.g. Skype) installed in computer to make and receive calls and faxes. Generally these VoIP calls are free, some with low rate when making calls to POTS phones.

With current solution of VoIP over ADSL, a user needs a computer, a head speaker, a microphone, and specific software installed in computer to work together as a phone. The head speaker and microphone are voice out/input equipments, the computer installed with the software gets access to Internet, connects with the VoIP service provider, controls the signaling setup of the call, communicate with remote party for codec negotiation, and processes the voice encoding/decoding in real time conversation.

It is inconvenient to use those equipments to work as a phone, users of such system need to manually setup the hardware/software environment, and the most troublesome problem is we could no longer reach the callee using the traditional E.164 number. Users find each other with the network ID (sometimes a nick name or a user name got from the Internet VoIP service provider) instead of E.164 numbers in common use .

Therefore, traditional ADSL solution can only make users enjoy traditional voice calls and Internet access respectively and thus pay for traditional voice calls and Internet access respectively.

### SUMMARY OF THE INVENTION

The present invention provides a method for bridging traffic in analogue channel into Internet using ADSL, and an ADSL modem for implementing the method and making users encode analogue signals into digital signals to deliver to Internet and decode received digital signals into analogue signals to deliver to phones or other analogue equipments such as faxes connected thereto. Furthermore, the present invention also provide an Internet call server for carrying out call discovery and connection between such ADSLs.

In the method of the invention for transferring traffic in analogue channel into digital channel using Asymmetrical Digital Subscriber Line ADSL, the analogue channel is a channel through Public Switched Telephone Network PSTN, the digital channel is a channel through Internet, said method mainly comprises:

step of PSTN network connecting, in which caller ADSL and callee ADSL establish PSTN network connection using PSTN signaling in the analogue channel;

step of discovering Internet call, in which the caller ADSL sends Internet call setup message to call server of the Internet at the same time of initiating PSTN network connection, the caller ADSL and the callee ADSL make Internet call discovery procedure on the Internet and determine successful Internet call discovery;

step of setting up Internet connection, in which the caller ADSL and the callee ADSL set up Internet connection in the digital channel by means of the successful Internet call discovery;

step of bridging the PSTN network connection to Internet, in which the caller ADSL and the callee ADSL transfer the PSTN network connection to the Internet via the Internet connection which has been set up, and release the analogue channel.

The present invention also provides a modem used in the method mentioned above, the modem includes:

analogue-signal receiving/transmitting module for receiving/transmitting analogue signals;

digital-signal receiving/transmitting module for receiving/transmitting digital signals;

codec module connected with the analogue-signal receiving/transmitting module and the digital-signal receiving/transmitting module, for encoding the analogue signals from the analogue-signal receiving/transmitting module into IP data packets to deliver to the digital-signal receiving/transmitting module and/or decoding the digital signals from the digital-signal receiving/transmitting module into analogue signals to deliver to the analogue-signal receiving/transmitting module, if necessary;

analysis module connected with the codec module, for analyzing network information of the caller and the callee and authenticating the caller and the callee;

control module connected with each of other modules of the modem for controlling their operations;

storage module connected with each of other modules of the modem for storing set data and programs of the modem.

The present invention also provides an Internet call server for carrying out call discovery and connection used in the method mentioned above, the server comprises:

message receiving/transmitting module for receiving/transmitting messages comprising call setup message, call request inquiry message, Internet call connection request message and call setup reject message;

storage module connected with the message receiving/transmitting module for storing the messages;

call discovery module connected with the storage module for searching in the storage module to find if there is Internet call setup message matching with the Internet call request inquiry message, when the callee ADSL sends the call request inquiry message to the Internet call server;

control module connected with each of other modules of the Internet call server for controlling their operations;

call connecting module connected with the control module for setting up or disconnecting the call connection.

The method and the ADSL modem of the present invention control a call in analogue channel or digital channel in the twisted-pair telephone lines. Thus, the present invention reuses the traditional E.164 telephone number to find the callee in the PSTN network, establish calls by means of VoIP server in the PSTN network and the Internet for communication, and finally bridges the analogue voice in analogue channel to digital channel after the call is set up in VoIP network. The user makes and receives phone calls just like making and receiving normal PSTN calls, only with the POTS phone connected with the enhanced ADSL modem, without knowing the transmission network is changed from PSTN to Internet. The calls will be charged at a far lower rate since it uses shared bandwidth to communicate, instead of full-occupied PSTN channel.

### BRIEF DESCRIPTION OF THE DRAWINGS

The detailed implementation of the present invention will be explained in conjunction with the accompanying drawings, in which:

FIG. 1 is a schematic diagram of VoIP network provided with a gateway and connected to PSTN according to prior arts;

FIG. 2 is a schematic diagram of transmitting voice on Internet provided with a gateway and connected to PSTN according to prior arts;

FIG. 3 is a schematic diagram of ADSL network architecture according to prior arts;

FIG. 4 is a schematic diagram of bridging PSTN calls into Internet according to the present invention;

FIG. 5 is a schematic diagram of establishing PSTN call connection according to the present invention;

FIG. 6 is a flow chart of establishing PSTN call connection according to the present invention;

FIG. 7 is a flow chart of Internet call discovery according to the present invention;

FIG. 8 is a flow chart of establishing Internet connection according to the present invention;

FIG. 9 is an architecture diagram of the ADSL modem according to a embodiment of the present invention;

FIG. 10 an architecture diagram of the ADSL modem according to another embodiment of the present invention;

FIG. 11 is an architecture diagram of the call server according to the present invention.

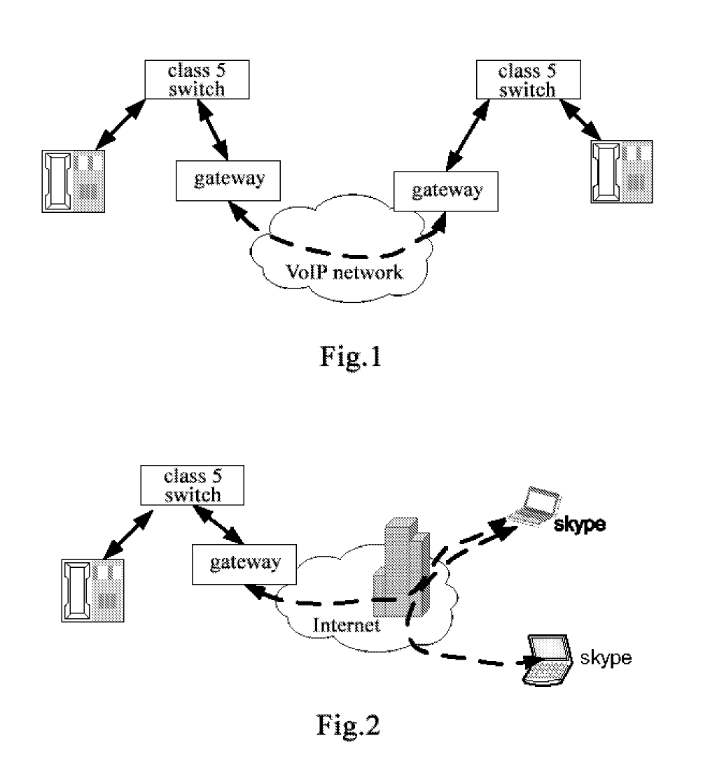

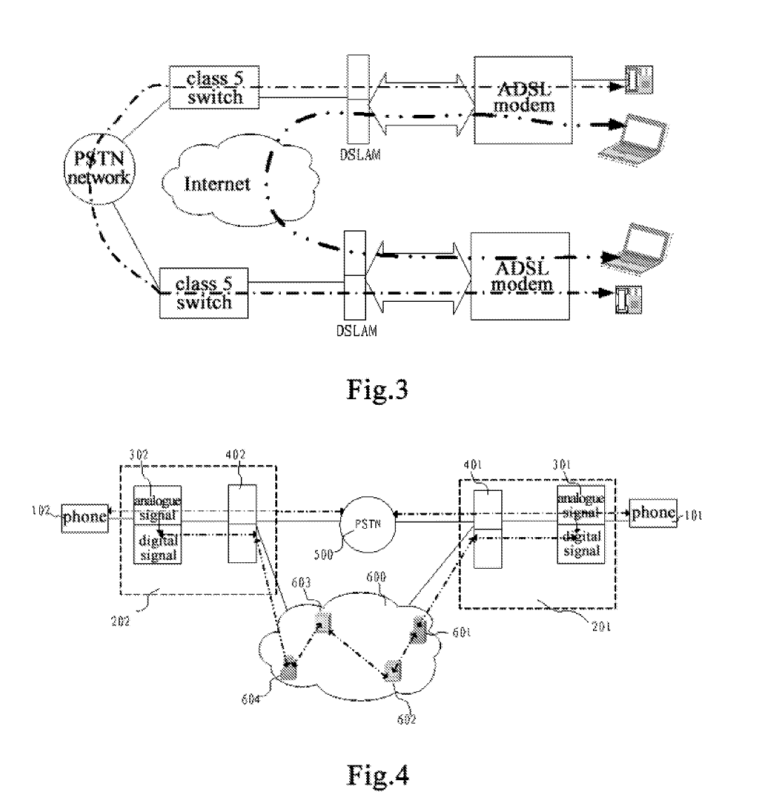

### DETAILED DESCRIPTION OF EMBODIMENTS OF THE INVENTION

In the method for bridging traffic in the analogue channel into the digital channel using ADSL, the analogue channel is a channel through Public Switched Telephone Network PSTN, the digital channel is a channel through Internet. FIG. 4 is a system schematic diagram of bridging PSTN calls into Internet. The system includes: phone 101 on caller side, ADSL 201 on caller side, PSTN 500, Internet 600, phone 102 on callee side and ADSL 202 on callee side. Further, ADSL 201 includes ADSL modem 301 and DSLAM (Digital Subscriber Line Access Multiplexer) 401, ADSL 202 includes ADSL modem 302 and DSLAM 402, and Internet 600 includes Internet call servers 601, 602, 603 and 604. In this FIG. 4, the dash-dot-dot lines represent the digital channels and the dot-and-dash lines represent the analogue channels. The embodiment mainly comprises steps as follows:

the caller ADSL and callee ADSL establish PSTN network connection using PSTN signaling in the analogue channel;

the caller ADSL sends Internet Call_Setup message to call server of the Internet, the caller ADSL and the callee ADSL make Internet call discovery procedure on the Internet and determine successful Internet call discovery;

the caller ADSL and the callee ADSL establish Internet connection in the digital channel by means of the successful Internet call discovery;

the caller ADSL and the callee ADSL transfer the PSTN network connection to the Internet via the Internet connection which has been set up, and release the analogue channel.

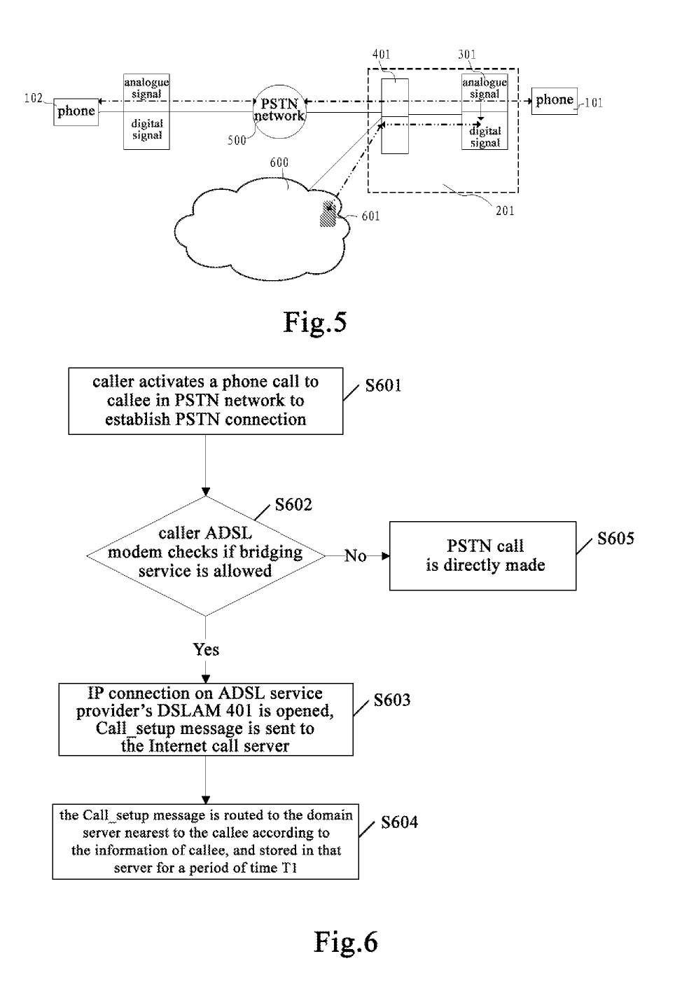

First, PSTN network connection is to be established, as shown in FIGS. 5 and 6. When user 101 initiates a call, PSTN network 500 will route the call to callee 102 via PSTN signaling, taking ISDN user part (ISUP) for example, initial address message (IAM) is sent to callee's switch (not shown). Callee POTS phone will start ringing, and backward ISUP message is sent back to originating PSTN switch which stars to play audible ring to caller from PSTN network 500 (S601). During this setup process, caller ADSL modem 201 will check if it is allowed to bridge the call in analogue channel to Internet (S602). If it is allowed, IP connection on ADSL service provider's DSLAM 401 is opened, a Call_setup message is sent to the Internet VoIP call discovery server 601 for its local domain (S603). This message contains the full E. 164 number for callee, a hash value of the full E. 164 number of caller, the socket information of the caller, and a codec list which this socket supports, wherein the E.164 number can be full E.164 number. The call server can be a distributed server operating as call discovery server or server for local domain.

The Call_setup message is routed to the Internet server 604 nearest to the callee according to the network information such as the E. 164 number of callee, and stored in that server for a period of time T1 (S604). The flow chart of FIG. 6 generally illustrates PSTN network connecting. Additionally, caller ADSL checking if it is allowed to bridge the call in analogue to Internet can further comprise checking the number of the callee is a free number, such as 119, 911, 110, 120 or 800 (the called party is charged the cost of the calls by the telephone) and if it is, makes PSTN directly instead of bridging to Internet (S605).

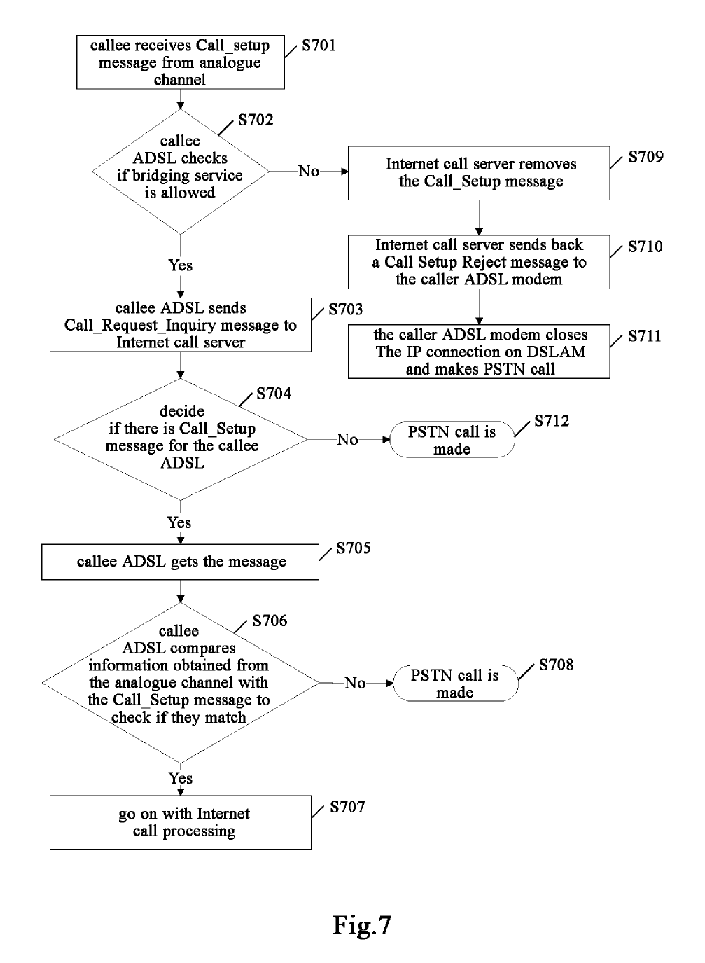

Next is the step of Internet call discovery. As seen from FIG. 7, upon receiving the Call_setup message from the analogue channel (S701), callee ADSL 202 checks if it is allowed to bridge to analogue channel to Internet (S702). If it is allowed, callee ADSL 202 sends a Call_Request_Query message to the Internet call server such as the nearest call server 604 (S704) and checks if there is a Call_Setup message for it, based on callee's network information such as the E.164 number (S704), if so gets the message (S705). The E.164 number of caller from the analogue channel is retrieved, the hash value of it is calculated. The hash value is compared with hash data in Call_setup message (S706), if they match, go on with Internet call processing (S707), if they don't match, drop the call (S708). Callee ADSL 202 checking if it is allowed to bridge to analogue channel to Internet comprises checking whether callee ADSL 202 or its modem supports VoIP function and nonsupport implies non-permissible. If it is not allowed to bridge analogue channel to Internet, then PSTN call is made. Operations of checking and message sending can be implemented by modems. Internet calls can be based on authorization of E.164 number, thus security of PSTN network will be inherited and existing numbering schemes of PSTN numbers can be used, so that broadest user base can be obtained.

If the Internet call server does not receive the Call_Request_Query message that corresponds to Internet Call_setup message during T1 from the callee (“NO” branch), it is indicated that bridging the PSTN call into Internet is not allowed or bridging function is not supported by callee ADSL 302. Then, the Internet call server removes the Internet Call_Setup message (S709) and sends back a Call_Setup_Reject message to caller ADSL modem 301 (S710). Next, caller ADSL modem 301 closes the IP connection on service provider's DSLAM and proceeds this call as a normal PSTN call (S711). Therefore, Internet connection can only be established in case matching Internet call is found. It is not necessary to keep users in register state on Internet (or specific VoIP network) as required by traditional VoIP phone.

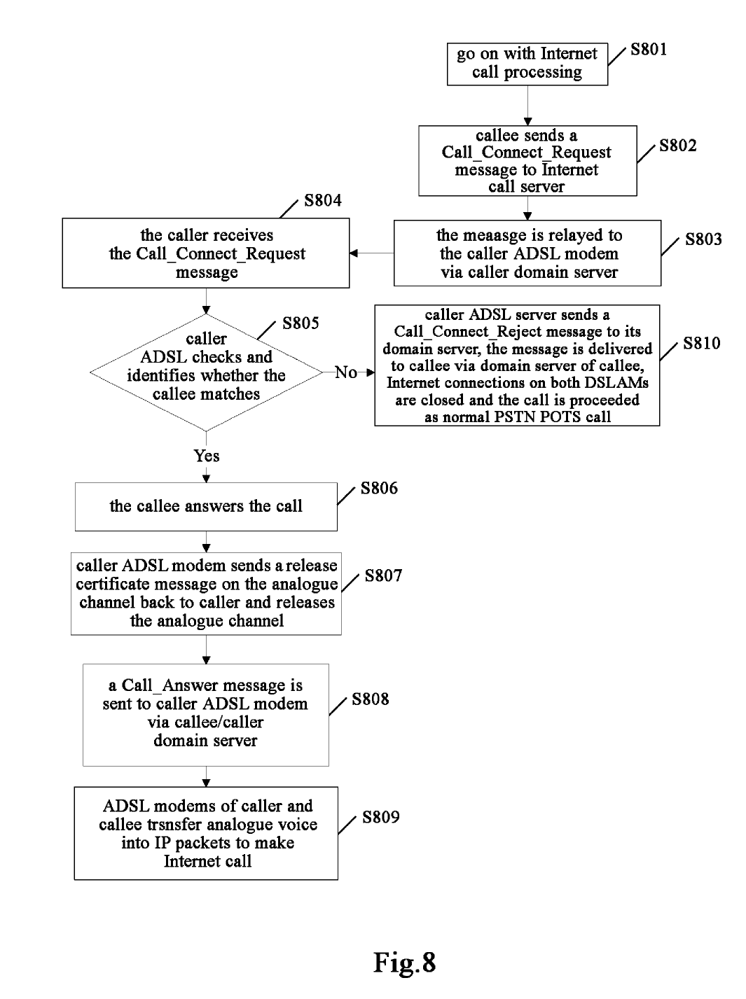

In the procedure of setting up Internet connection, if it determines to go on with the call processing in step 801 (that is the same step as step 707), as shown in FIG. 8, ADSL modem 302 will pick a codec from the caller codec list retrieved from the Call_Setup message and open an IP connection on the ADSL service provider's DSLAM 402, send a Call Connect_Request message to Internet call server such as the nearest call server 604 (S802). This message is relayed to caller ADSL modem 301 via Internet call servers such as 603, 602, 601 (S803). The message contains network information, for example, callee's IP connection information and a hash value of caller's E.164 number, and the selected codec which will be used in the upcoming conversation.

Caller ADSL 301 receives the Call Connect_Request message (in S804), checks the message and identifies the callee based on the network information of caller and callee such as of E. 164 numbers (S805). If the check fails (“NO” branch of S804), caller ADSL modem 301 will send a Call_Connect_Reject message to Internet call server such as 601 and deliver it to callee via Internet. IP connections on both DSLAMs are closed and this call is proceeded as a normal PSTN call (S810).

The ADSLs may be deployed behind a firewall to the Internet access. Some technologies exist to do firewall traversal so that the Internet users behind firewalls can exchange data without barriers. For example, the Skype uses a technology called P2P (peer-to-peer) to do firewall and private network traversal.

If the check succeeds, that is the callee to be contacted is identified, then PSTN connection can be bridged to Internet (‘YES’ branch in S805). The callee answers the call (S806), and callee ADSL modem 302 sends a release certificate message on the analogue channel back to caller and releases all the full-occupied analogue channels (S807). Then a Call_Answer message is sent to caller ADSL modem 301 via Internet call servers such as 604-601 (S808). ADSL modems of caller 301 starts to convert the analogue signals such as analogue voice and other media into IP data packets and send these packets to callee ADSL 202, thus a two way communication between caller and callee is established (S809).

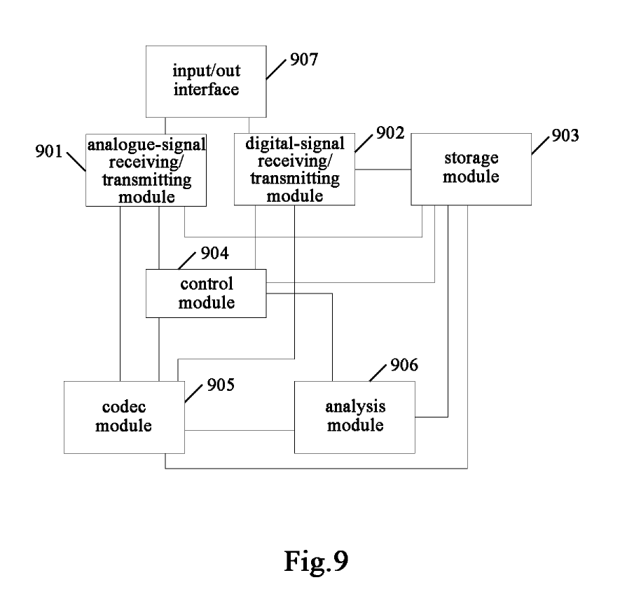

FIG. 9 is an architecture diagram of the ADSL modem according to the present invention. ADSL modem is a device configured on user side. The ADSL modem according to the present invention has two operation modes, PSTN mode and IP mode for a call of analogue signal, wherein a call of analogue signal refers to POTS phone call, fax or other analogue call. When a system does not support or select the bridging service for bridging PSTN call into Internet call provided by the present invention, the modem can operate under PSTN mode and proceed calls as normal PSTN calls When a system supports and selects the bridging service for bridging PSTN call into Internet call provided by the present invention, the modem can operate under IP mode, that is, the modem can bridge PSTN calls into Internet. The modem in FIG. 9 include analogue-signal receiving/transmitting module 901, digital-signal receiving/transmitting module 902, codec module 905, analysis processing module 906, control module 904 and storage module 903.

Analogue-signal receiving/transmitting module 901 can be used to receive/transmit analogue signals; digital-signal receiving/transmitting module 902 can be used to receive/transmit digital signals. Module 901 and module 902 may be connected to input/output interface 907. Analogue signals contain a dual tone multi-frequency (DTMF) signal on analogue channel such as analogue voice signal of POTS phone, fax signal or other analogue signal. The digital signal contains VoIP data packets from digital channels.

Codec module 905 is connected with the analogue-signal receiving/transmitting module and the digital-signal receiving/transmitting module, for encoding the analogue signals from the analogue-signal receiving/transmitting module into IP packets to deliver to the digital-signal receiving/transmitting module and/or decoding the digital signals from the digital-signal receiving/transmitting module into analogue signals to deliver to the analogue-signal receiving/transmitting module. It is not needed to convert calls when codec module 905 works under PSTN mode; this module can encode analogue signals for example from POTS phone set into VoIP data packets and send them from the interface opened on service provider's DSLAM. Also, codec module 905 can decode VoIP data packets received from the interface opened on service provider's DSLAM into analogue voice to be sent to POTS phone.

Analysis processing module 906 is connected with the codec module, for analyzing network information of the caller and the callee and authenticating the caller and the callee. Additionally, this module can analyze whether the number of the callee is a free number such as 119, 911, 110, 120 or 800, and if it is, the modem can work in PSTN mode and makes PSTN call instead of bridging to Internet.

Control module 904 is connected with each of other modules of the modem for controlling their operations. This module controls operation of other module based on analysis processing results of the analysis processing module 906 or settings that users set for the modem, for example, to decide whether the modem must work under IP mode.

Storage module 903 is connected with each of other modules of the modem for storing set data and programs of the modem.

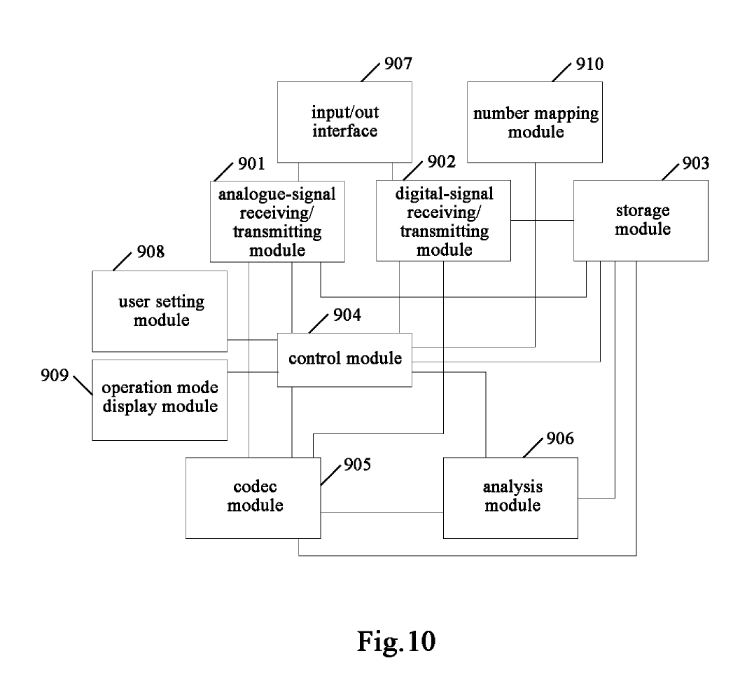

As another preferred embodiment of the present invention FIG. 10, the ADSL modem can further includes user setting module 908 for user to configure the modem for example to permit/forbidden VoIP function and to set VoIP service settings.

Additionally operation mode display module 909 can be provided, for indicating what mode the user's call is, PSTN mode or VoIP mode. Using the modem of the present invention, it looks as if a user initiates and receives PSTN phone call, without knowing whether his/her call is bridged from a PSTN network to Internet. However if operation mode display module 909 is provided, he/she will know whether his/her call is bridged from a PSTN network to Internet or not.

Furthermore, number mapping module 910 can be provided for mapping a short number into a full number that the user needs to dial out.

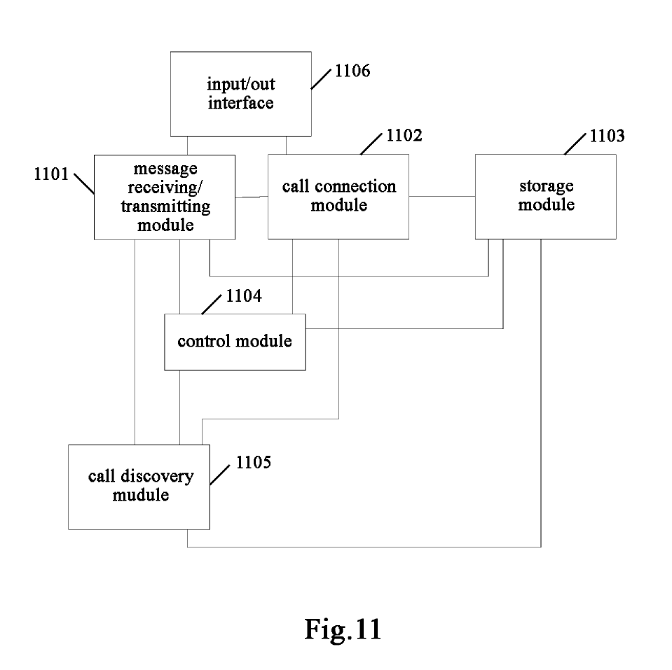

FIG. 11 is an architecture diagram of the call server according to the present invention. As shown in FIG. 11, the server includes: message receiving/transmitting module 1101, storage module 1103, call discovery module 1105, control module 1104 and call connection module 1102. Message receiving/transmitting module 1101 can be used to receive/transmit messages comprising Call_Setup message, Call_Request_Inquiry message, Internet_Call_Connection_Request message and Call_Setup_Reject message. Storage module 1103 is connected with the message receiving/transmitting module 1101 for storing the messages; call discovery module 1105 is connected with the storage module 1103 for searching in the storage module to find if there is Internet call setup message matching with the Internet_Call_Request_Inquiry message when callee ADSL sends Call_Request_Inquiry message to Internet call server. At this time, Call_Setup message of the caller and Call_Request_Inquiry message are compared. For example, E. 164 number of the callee, the hash value of the E. 164 number of the caller, socket information of the caller and the list of codecs supported by the socket of the caller ADSL are compared with the information indicated in the Internet Call_Request_Inquiry message, if they match, it can be determined to proceed Internet call, if they don't match or the server has not received any Call_Request_Inquiry message, which implies there is not matched Call_Setup message. Control module 1104 is connected with each of other modules of the Internet call server for controlling their operations. And call connection module 1105 is connected with the control module for setting up or disconnecting the call connection. When call discovery module 1105 finds matched Call_Setup message and Call_Request_Inquiry message, control module 1104 causes call connecting module 1105 to establish call connection of the matched caller and callee in Internet. When there are no matched Call_Setup message and Call_Request_Inquiry message, including the case that no Call_Request_Inquiry message from the callee is received, then control module 1104 removes the Call_Setup message stored in the storage module.

As seen from above, bridging traffic on PSTN network into Internet using the present invention would let users achieve free or low rate long distance call without VoIP gateways.

The embodiments described above are not exclusive, although the method and the modem of the present invention are described in details by means of exemplary examples. One skilled in the art can make various modification or adaptation in the sprit and range of the present invention. Therefore, the invention is not limited to these embodiments. The range of the invention is defined with appended claims.

1. A method for bridging traffic in an analogue channel into a digital channel using Asymmetrical Digital Subscriber Line ADSL, the analogue channel being channel through Public Switched Telephone Network PSTN, the digital channel being channel through Internet, said method comprises:
step of PSTN network connecting, in which caller ADSL and callee ADSL establish PSTN network connection using PSTN signaling in the analogue channel;
step of discovering Internet call, in which the caller ADSL sends Internet call setup message to Internet call server, the caller ADSL and the callee ADSL make Internet call discovery procedure on the Internet and determine successful Internet call discovery;
step of setting up Internet connection, in which the caller ADSL and the callee ADSL set up Internet connection in the digital channel by means of the successful Internet call discovery;
step of bridging the PSTN network connection to the Internet, in which the caller ADSL and the callee ADSL bridge the PSTN network connection to the Internet via the Internet connection which has been set up, and release the analogue channel.

2. The method according to claim 1, wherein the callee ADSL sends Internet call request inquiry message in the step of discovering Internet call and it is determined to be successful Internet call discovery when the Internet call setup message matches with the Internet call request inquiry message.

3. The method according to claim 1, wherein the step of setting up Internet connection comprises: the callee ADSL sends Internet call connection request message to the caller ADSL via the Internet call server, the caller ADSL and the callee ADSL set up Internet connection when the caller ADSL decides that the callee ADSL is just the callee to be contacted.

4. The method according to claim 1, wherein the caller ADSL and the callee ADSL convert analogue signals into IP packets to transmit in the digital channel in the step of bridging the PSTN network connection to the Internet.

5. The method according to claim 1, wherein the caller ADSL calls the callee ADSL in accordance with network information of the callee ADSL and the callee ADSL obtains network information of the caller ADSL in the step of PSTN network connecting.

6. The method according to claim 5, wherein the Internet call setup message contains the network information of the caller ADSL and the network information of the callee ADSL, in the step of discovering Internet call.

7. The method according to claim 1, wherein the Internet call server is distributed server.

8. The method according to claim 1, wherein the Internet connection comprises point to point connection.

9. The method according to claim 1, wherein the network information of the caller ADSL contains E.164 number of the caller and the network information of the callee ADSL contains E. 164 number of the callee.

10. The method according to claim 1, wherein the Internet call setup message contains the network information of the caller ADSL and the network information of the callee ADSL.

11. The method according to claim 1, wherein the network information of the caller ADSL contains socket information of the caller ADSL and the list of codecs supported by the socket of the caller ADSL; and
the network information of the callee ADSL contains socket information of the callee ADSL and the list of codecs supported by the socket of the callee ADSL.

12. The method according to claim 1, wherein the Internet call request inquiry message and the Internet call connection request message contain the network information of the caller ADSL and/or the network information of the callee ADSL.

13. The method according to claim 1, wherein the PSTN network connection in the analogue channel comprises voice call and/or fax call.

14. The method according to claim 1, wherein in the step of setting up Internet connection, the caller ADSL checks whether the number of the callee is a free number, and if it is, a PSTN call is made directly.

15. An ADSL modem comprising:
analogue-signal receiving/transmitting module for receiving/transmitting analogue signals;
digital-signal receiving/transmitting module for receiving/transmitting digital signals;
codec module connected with the analogue-signal receiving/transmitting module and the digital-signal receiving/transmitting module, for encoding the analogue signals from the analogue-signal receiving/transmitting module into IP data packets to deliver to the digital-signal receiving/transmitting module and/or decoding the digital signals from the digital-signal receiving/transmitting module into analogue signals to deliver to the analogue-signal receiving/transmitting module, if necessary;
analysis module connected with the codec module, for analyzing network information of the caller and the callee and authenticating the caller and the callee;
control module connected with each of other modules of the modem for controlling their operations;
storage module connected with each of other modules of the modem for storing set data and programs of the modem.

16. The modem according to claim 15, wherein the modem further includes user setting module connected with the control module for user to configure the modem to permit/forbidden VoIP function and to set VoIP service settings.

17. The modem according to claim 15, the analogue signal comprises a dual tone multi-frequency signal on the analogue channel, the digital signal comprises VoIP data packets from digital channels.

18. The modem according to claim 15, wherein the modem further includes operation mode display module connected with the control module for indicating the user's call is PSTN mode or VoIP mode.

19. The modem according to claim 15, wherein when the modem is set to operate in VoIP mode and is able to establish connection with the callee in the digital channel, the analogue signal received via the digital-signal receiving/transmitting module is converted into IP data packets by means of the codec module and the IP data packets are bridged to the digital channel to realize communication between the caller ADSL and the callee ADSL,
when the modem is set to operate in PSTN mode or when the modem is set to operate in VoIP mode but is unable to establish connection with the callee in the digital channel, communication between the caller ADSL and the callee ADSL is realized in the analogue channel.

20. The modem according to claim 15, wherein the modem further includes number mapping module for mapping a short number into a full number that the user needs to dial out according to the user's settings.

21. The modem according to claim 15, wherein the analysis module analyzes whether the number of the callee is a free number when the user makes a call, and if it is, the control module will set the modem in PSTN mode.

22. An Internet call server for carrying out call discovery and connection, the server comprising:
message receiving/transmitting module for receiving/transmitting messages comprising call setup message, call request inquiry message, Internet call connection request message and call setup reject message;
storage module connected with the message receiving/transmitting module for storing the messages;
call discovery module connected with the storage module for searching in the storage module to find if there is Internet call setup message matching with the Internet call request inquiry message, when the callee ADSL sends the call request inquiry message to the Internet call server;
control module connected with each of other modules of the Internet call server for controlling their operations;
call connection module connected with the control module for setting up or disconnecting the call connection.
